(19) United States
(12) Patent Application Publication
(10) Pub. No.: US 2023/0253615 A1
(43) Pub. Date: Aug. 10, 2023

(54) GALLIUM AND TELLURIUM-DOPPED SOLID ELECTROLYTE, METHOD FOR PREPARING THE SAME, AND ALL-SOLID-STATE BATTERY INCLUDING THE SAME

(71) Applicants: ULSAN NATIONAL INSTITUTE OF SCIENCE AND TECHNOLOGY, Ulsan (KR); MICO LTD, Anseong-si (KR)

(72) Inventors: Gun Tae KIM, Ulsan (KR); A Rim SEONG, Ulsan (KR); Hyo I JO, Hyo I (KR)

(21) Appl. No.: 18/166,609

(22) Filed: Feb. 9, 2023

(30) Foreign Application Priority Data
Feb. 9, 2022 (KR) 10-2022-0016993

(51) Int. Cl. H01M 10/0562

(52) U.S. Cl. CPC H01M 10/0562; H01M 2300/0071

(57) ABSTRACT

Disclosed is solid electrolyte containing gallium and tellurium-doped lithium lanthanum zirconium oxide (LLZO), a method for preparing the same, and an all-solid-state battery including the same. The all-solid-state battery including the solid electrolyte containing gallium and tellurium-doped lithium lanthanum zirconium oxide (LLZO) exhibits excellent electrochemical performance.

### CROSS-REFERENCE TO RELATED APPLICATION

This application claims the benefit under 35 U.S.C. § 119a of Korean Patent Application No. 10-2022-0016993 filed Feb. 9, 2022, in the Korean Intellectual Property Office, the entire contents of which are hereby incorporated by reference in their entirety for all purposes.

### BACKGROUND

### Field of the Invention

The present disclosure relates to a gallium and tellurium-doped solid electrolyte, a method for preparing the same, and an all-solid-state battery including the same. More specifically, the present disclosure relates to a solid electrolyte including gallium and tellurium-doped lithium lanthanum zirconium oxide (LLZO), a method for preparing the same, and an all-solid-state lithium secondary battery including the same.

### Description of Related Art

An all-solid-state lithium-ion battery in which flammable liquid electrolyte is replaced with solid electrolyte is receiving a lot of attention because the all-solid-state lithium-ion battery can eliminate the risk of explosion to secure the most important stability. Further, the all-solid-state lithium-ion battery is considered as a next-generation battery due to following reasons in addition to the stability. First, the in addition to the stability may use a new active material with a high energy density that has not been used in organic liquid electrolyte. An electrical potential window of the organic liquid electrolyte is lower than or equal to 4.5V. When the potential window exceeds 4.5V, performance degradation occurs due to electrolyte structure collapse. However, an electrical potential window of the solid electrolyte is 5V or higher, and thus a new positive electrode material having a higher voltage is applied to the all-solid-state lithium-ion battery so as to increase an energy density. Second, the solid electrolyte has a high Young's modulus and a high transfer number. Thus, formation of lithium dendrite may be theoretically suppressed, such that a currently used graphite negative electrode can be replaced with lithium metal, thereby maximizing a capacity of the battery. Third, an energy density may be increased in cell packaging. When packaging cells for a medium and large-sized battery, and when using the liquid electrolyte, each cell should be sealed and then the cells should be assembled into a module and a pack. However, when using the solid electrolyte, multiple cells may be stacked to form an assembly which in turn may be sealed. Therefore, assuming that the cell performance is constant, a volume of the module when using the solid electrolyte may be reduced by 20% compared to that when using the liquid electrolyte, such that the energy density per volume may be increased.

The solid electrolyte of the all-solid-state lithium-ion battery may be classified into polymer electrolyte and ceramic electrolyte. Research on sulfide-based and oxide-based ceramic electrolytes is mainly conducted. The sulfide-based solid electrolyte has ionic conductivity of 10⁻² S/cm or greater, which is as good as that of the liquid electrolyte. The sulfide-based solid electrolyte may be sintered only using cold pressing. Thus, a bulk type all-solid-state battery can be manufactured using the same. Thus, research on commercialization thereof is being actively conducted. However, the sulfide-based solid electrolyte may react with oxygen and moisture in the air to produce hydrogen sulfide (H₂S) as a deadly toxic substance. When the sulfide-based solid electrolyte comes in contact with an oxide-based positive electrode active material, a side reaction may occur which may increase a process cost due to sealing and interface treatment. Further, because the sulfide-based solid electrolyte reacts with lithium metal, high-capacity lithium metal cannot be used as a material of a negative electrode.

On the other hand, the oxide-based solid electrolyte has excellent chemical stability against various substances, and is capable of minimizing production of toxic substances or by-products. LATP (Li_{1.3}Al_{0.3}Ti_{1.7}(PO₄)₃), LLTO (Li₃ₓLa_{2/(3-x)}TiO₃), and LLZO (Li₇La₃Zr₂O₁₂) are widely known as the oxide-based solid electrolyte. Among them, LLZO has high ionic conductivity, low reactivity with an electrode material, and a wide potential window (0 to 6V). However, it is difficult to determine a process condition due to volatilization of lithium (Li) in a sintering process of the LLZO. A complexity of a preparing process of the LLZO increases because it is difficult to sinter the LLZO. Further, there is a large variation in the ionic conductivity of the LLZO based on a crystal structure. Thus, it is necessary to develop technology to control the crystal structure of the LLZO.

### SUMMARY OF THE INVENTION

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter.

A purpose of the present disclosure is to provide an LLZO-based solid electrolyte for an all-solid-state battery with excellent ionic conductivity and potential window characteristics, a method for preparing the same, and an all-solid-state battery including the same.

A first aspect of the present disclosure provides solid electrolyte containing a lithium lanthanum zirconium oxide-based compound doped with gallium (Ga) and tellurium (Te), wherein the lithium lanthanum zirconium oxide-based compound doped with gallium (Ga) and tellurium (Te) is represented by a following Chemical Formula 1:

Liₐ₋ₓGaₓLa_{b}Zr_{c-y}Te_{y}O₁₂

(5≤a≤9,0<x≤4,2≤b≤4,1≤c≤3,0<y<1). [Chemical Formula 1]

In one implementation of the solid electrolyte, the lithium lanthanum zirconium oxide-based compound doped with gallium (Ga) and tellurium (Te) is represented by a following Chemical Formula 2:

Li₇₋ₓGaₓLa₃Zr_{2-y}Te_{y}O₁₂

(0<x≤3,0<y<1) [Chemical Formula 2]

In one implementation of the solid electrolyte, the lithium lanthanum zirconium oxide-based compound doped with gallium (Ga) and tellurium (Te) has a garnet cubic phase.

In one implementation of the solid electrolyte, the solid electrolyte further contains γ-Al₂O₃.

A second aspect of the present disclosure provides a method for preparing the solid electrolyte as described above, the method comprising: (a) mixing a lithium precursor, a gallium precursor, a lanthanum precursor, a zirconium precursor, and a tellurium precursor with each other to prepare a mixture, and ball-milling the mixture; and (b) calcinating the ball-milled mixture.

In one implementation of the method, the ball-milling includes planetary ball-milling.

In one implementation of the method, (a) further includes mixing the mixture with a solvent before the ball-milling.

In one implementation of the method, the ball-milling is performed at 300 to 700 rpm.

In one implementation of the method, the lithium precursor, the gallium precursor, the lanthanum precursor, the zirconium precursor, and the tellurium precursor are Li₂O₃, Ga₂O₃, La₂O₃, ZrO₂, and TeO₂, respectively.

In one implementation of the method, the method further comprises (c) ball-milling the calcinated mixture after (b).

In one implementation of the method, the method further comprises adding 7-Al₂O₃ to the calcinated mixture before (c).

In one implementation of the method, the ball-milling in (c) includes planetary ball-milling.

A third aspect of the present disclosure provides an all-solid-state battery comprising: a positive electrode; a negative electrode; and solid electrolyte interposed between the positive electrode and the negative electrode, wherein the solid electrolyte includes the solid electrolyte as described above.

The gallium and tellurium-doped solid electrolyte according to the present disclosure has excellent ionic conductivity and potential window characteristics, thereby providing the all-solid-state battery with improved electrochemical characteristics such as charge/discharge performance and energy efficiency.

In addition to the effects as described above, specific effects in accordance with the present disclosure will be described together with following detailed descriptions for carrying out the disclosure.

### BRIEF DESCRIPTION OF DRAWINGS

FIG. 1A is a graph of an XRD analysis result based on a calcination condition of solid electrolyte as prepared according to Comparative Example 1.

FIG. 1B is a graph of an XRD analysis result based on a calcination condition of solid electrolyte as prepared according to Present Example 1.

FIG. 2A is an X-ray diffraction analysis graph based on a calcination condition of solid electrolyte in an all-solid-state battery as prepared according to Comparative Example 2.

FIG. 2B is an X-ray diffraction analysis graph of an all-solid-state battery including solid electrolyte calcinated for 4 hours at a temperature of 1050° C. in FIG. 2A.

FIG. 2C is an X-ray diffraction analysis graph of an all-solid-state battery including solid electrolyte calcinated for 8 hours at a temperature of 1050° C. in FIG. 2A.

FIG. 2D is an X-ray diffraction analysis graph of an all-solid-state battery including solid electrolyte calcinated for 12 hours at a temperature of 1050° C. in FIG. 2A.

FIG. 3A is an X-ray diffraction analysis graph based on a calcination condition of solid electrolyte in an all-solid-state battery as prepared according to Present Example 2.

FIG. 3B is an X-ray diffraction analysis graph of an all-solid-state battery including solid electrolyte calcinated for 4 hours at a temperature of 1050° C. in FIG. 3A.

FIG. 3C is a graph of X-ray diffraction analysis of an all-solid-state battery including solid electrolyte calcinated for 8 hours at a temperature of 1050° C. in FIG. 3A.

FIG. 3D is an X-ray diffraction analysis graph of an all-solid-state battery including solid electrolyte calcinated for 12 hours at a temperature of 1050° C. in FIG. 3A.

FIG. 4 is a graph showing electrical conductivity based on a calcination condition of solid electrolyte in the all-solid-state battery as prepared according to each of Present Example 2 and Comparative Example 2.

### DETAILED DESCRIPTION OF THE INVENTION

Examples of various embodiments are illustrated and described further below. It will be understood that the description herein is not intended to limit the claims to the specific embodiments described. On the contrary, it is intended to cover alternatives, modifications, and equivalents as may be included within the spirit and scope of the present disclosure as defined by the appended claims. Further, descriptions and details of well-known steps and elements are omitted for simplicity of the description. Furthermore, in the following detailed description of the present disclosure, numerous specific details are set forth in order to provide a thorough understanding of the present disclosure. However, it will be understood that the present disclosure may be practiced without these specific details. In other instances, well-known methods, procedures, and components have not been described in detail so as not to unnecessarily obscure aspects of the present disclosure.

The terminology used herein is for the purpose of describing particular embodiments only and is not intended to limit the present disclosure. As used herein, the singular forms “a” and “an” are intended to include the plural forms as well, unless the context clearly indicates otherwise. It will be further understood that the terms “comprise”, “comprising”, “include”, and “including” when used in this specification, specify the presence of the stated features, integers, operations, elements, and/or components, but do not preclude the presence or addition of one or more other features, integers, operations, elements, components, and/or portions thereof. As used herein, the term “and/or” includes any and all combinations of one or more of the associated listed items. Expression such as “at least one of” when preceding a list of elements may modify an entirety of list of elements and may not modify the individual elements of the list. When referring to “C to D”, this means C inclusive to D inclusive unless otherwise specified.

Unless otherwise defined, all terms including technical and scientific terms used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “substantially,” “about,” and similar terms are used as terms of approximation and not as terms of degree, and are intended to account for the inherent deviations in measured or calculated values that would be recognized by those of ordinary skill in the art. The term may be used to prevent unauthorized exploitation by an unauthorized infringer to design around accurate or absolute figures provided to help understand the present disclosure.

In one example, when a certain embodiment may be implemented differently, a function or operation specified in a specific block may occur in a sequence different from that specified in a flowchart. For example, two consecutive blocks may actually be executed at the same time. Depending on a related function or operation, the blocks may be executed in a reverse sequence.

In descriptions of temporal relationships, for example, temporal precedent relationships between two events such as “after”, “subsequent to”, “before”, etc., another event may occur therebetween unless “directly after”, “directly subsequent” or “directly before” is not indicated.

The features of the various embodiments of the present disclosure may be partially or entirely combined with each other, and may be technically associated with each other or operate with each other. The embodiments may be implemented independently of each other and may be implemented together in an association relationship.

A lithium lanthanum zirconium oxide-based compound (hereinafter referred to as LLZO compound) doped with gallium (Ga) and tellurium (Te) which is contained in solid electrolyte according to the present disclosure is represented by a following Chemical Formula 1:

Liₐ₋ₓGaₓLa_{b}Zr_{c-y}Te_{y}O₁₂

(5≤a≤9,0<x≤4,2≤b≤4,1≤c≤3,0<y<1) [Chemical Formula 1]

The LLZO compound of the Chemical Formula 1 may be represented by a following Chemical Formula 2:

Li₇₋ₓGaₓLa₃Zr_{2-y}Te_{y}O₁₂

(0<x≤3,0<y<1) [Chemical Formula 2]

Preferably, in the Chemical Formula 2, 0<x≤0.5 and 0<y<0.5. When x is too small, a garnet cubic phase cannot be formed. When x exceeds 0.5, a Li content is too small and thus the conductivity is reduced. Further, when y is too small, the garnet cubic phase cannot be formed. When y exceeds 0.5, the Li content is too small and thus the conductivity is reduced.

According to one implementation of the present disclosure, the gallium and tellurium-doped LLZO compound may have a garnet cubic phase.

Further, according to one implementation of the present disclosure, the solid electrolyte including the gallium and tellurium-doped LLZO compound may further contain γ-Al₂O₃. The γ-Al₂O₃ may be added for the purpose of improving the ionic conductivity and stability of the solid electrolyte. The γ-Al₂O₃ may be contained at a content of 5% by weight or smaller based on a total weight of the solid electrolyte.

According to one implementation of the present disclosure, the solid electrolyte including the gallium and tellurium-doped LLZO compound may have the ion conductivity in a range of 0.5×10⁻³ to 2.0×10⁻³ S/cm.

Another aspect of the present disclosure provides a method for preparing the solid electrolyte as described above, the method comprising: (a) mixing a lithium precursor, a gallium precursor, a lanthanum precursor, a zirconium precursor, and a tellurium precursor with each other to prepare a mixture, and ball-milling the mixture; and (b) calcinating the ball-milled mixture.

In one implementation of the method, the ball-milling includes planetary ball-milling.

In one implementation of the method, (a) further includes mixing the mixture with a solvent before the ball-milling.

In one implementation of the method, the ball-milling is performed at 300 to 700 rpm.

In one implementation of the method, the lithium precursor, the gallium precursor, the lanthanum precursor, the zirconium precursor, and the tellurium precursor are Li₂O₃, Ga₂O₃, La₂O₃, ZrO₂, and TeO₂, respectively.

In one implementation of the method, the method further comprises (c) ball-milling the calcinated mixture after (b).

In one implementation of the method, the method further comprises adding γ-Al₂O₃ to the calcinated mixture before (c).

In one implementation of the method, the ball-milling in (c) includes planetary ball-milling.

Another aspect of the present disclosure provides a method for preparing the solid electrolyte as described above, the method comprising: (a) mixing a lithium precursor, a gallium precursor, a lanthanum precursor, a zirconium precursor, and a tellurium precursor with each other to prepare a mixture, and ball-milling the mixture; (b) calcinating the ball-milled mixture; (c) adding an additional additive, for example, γ-Al₂O₃ to the calcinated mixture; and (d) ball-milling a mixture of the calcinated mixture and the additional additive.

In one implementation of the method, the lithium precursor, the gallium precursor, the lanthanum precursor, the zirconium precursor, and the tellurium precursor are Li₂O₃, Ga₂O₃, La₂O₃, ZrO₂, and TeO₂, respectively. In one example, the lithium precursor, the gallium precursor, the lanthanum precursor, the zirconium precursor, and the tellurium precursor may be mixed with each other at an appropriate mixing ratio according to a desired doped amount.

According to an embodiment, a ration of contents of Li₂O₃, Ga₂O₃, La₂O₃, ZrO₂, and TeO₂ may be in a range of 1:0.015 to 0.19:1.61 to 2.00:0.811 to 1.01:0 to 0.3. When the content of the lithium precursor is too small and is outside the above range, the lithium ion conductivity of the prepared solid electrolyte may be reduced. When the content of the lithium precursor is too large and is outside the above range, the garnet cubic phase cannot be formed.

In step (a), the precursors are ball-milled. Thus, the particles may be mechanically pulverized and mixed uniformly. The ball-milling may be planetary ball-milling. The ball-milling may be performed using a milling jar made of a material selected from tool steel, stainless steel, cemented carbide, silicon nitride, alumina and zirconia, and may be carried out using a ball made of a material selected from tool steel, stainless steel, cemented carbide, silicon nitride, alumina and zirconia. However, the present disclosure is not particularly limited thereto. The ball may have a diameter of 1 to 30. The balls may have the same size. Alternatively, balls having two or more sizes may be used together.

A speed or a time of the ball-milling may vary depending on a desired particle size. For example, the speed of the ball-milling may be in a range of 50 to 750 rpm or 300 to 700 rpm. For example, a time duration of the ball-milling may be in range of 1 to 48 hours.

In one implementation of the method, (a) further includes mixing the mixture with a solvent before the ball-milling. Thus, the ball-milling may be performed on a mixed solution in which the mixture is added to the solvent. The solvent is not particularly limited as long as performance of the solid electrolyte containing the resulting compound produced using the mixed solution in which the solvent and the precursors are mixed with each other is not lowered. For example, methanol, ethanol, or the like may be used as the solvent. When the solvent as described above is used, it is preferable to perform drying at an appropriate temperature after performing the ball-milling. A drying time and a drying temperature are not particularly limited. In one example, the drying may be performed at 60 to 100° C. for 2 to 20 hours.

The calcination of the milled mixture as described above may be carried out for 0.5 to 24 hours at a temperature of 800° C. to 1200° C., preferably, for 4 hours to 24 hours at a temperature of 950° C. to 1050° C. When the above-mentioned calcination temperature is lower than 800° C., and/or when the calcination time is smaller than 0.5 hour, the calcination may be insufficient. Further, when the above-mentioned calcination temperature exceeds 1200° C. and/or the calcination time is larger than 24 hours, a secondary phase may be formed due to the Li volatilization, which may increase the process time and increase a process cost accordingly. The calcination step may allow the mixture to be converted to the gallium and tellurium-doped LLZO compound.

After performing the calcination, the calcinated mixture may be further subjected to ball-milling. At this time, the calcinated mixture together with γ-Al₂O₃ may be ball-milled to improve the ionic conductivity and stability of the solid electrolyte. The γ-Al₂O₃ may be contained at a content of 5% or smaller by weight based on the total weight of the solid electrolyte. The further ball-milling may be embodied as planetary ball-milling and may be performed while the calcinated mixture has been mixed with a solvent. A milling speed and a milling time, a type of the solvent used, and a drying time and temperature of the solvent may refer to those in (a). However, the milling speed may not be equal to that in (a).

The solid electrolyte containing the compound according to the present disclosure as described above may be used as solid electrolyte in the all-solid-state battery.

The all-solid-state battery includes a positive electrode, a negative electrode, and the solid electrolyte interposed between the positive electrode and the negative electrode.

A thickness of the solid electrolyte in accordance with the present disclosure varies greatly depending on a structure of the all-solid-state battery. For example, the thickness of the solid electrolyte in accordance with the present disclosure may be in a range of 0.1 m to 1 mm, or in a range of 1 to 100 m. The solid electrolyte may further include a solid electrolyte commonly used in an all-solid-state battery, for example, an inorganic solid electrolyte or an organic solid electrolyte, in addition to the LLZO solid electrolyte of the present disclosure.

Examples of the inorganic solid electrolyte may include Thio-LISICON(Li_{3.25}Ge_{0.25}P_{0.75}S₄), Li₂S—SiS₂, LiI—Li₂S—SiS₂, LiI—Li₂S—P₂S₅, Li₂O—B₂O₃, Li₃PO₄, Li₂O—Li₂WO₄—B₂O₃, LiPON, LiBON, Li₅La₃Ta₂O₁₂, Li₆BaLa₂Ta₂O₁₂, Li₃PO_{(4-3/2w)}N_{w}(w<1), Li_{3.6}Si_{0.6}P_{0.4}O₄, etc.

Further, an example of the organic solid electrolyte may include a mixture of lithium salt with a polymer-based material such as polyethylene derivative, polyethylene oxide derivative, polypropylene oxide derivative, phosphoric acid ester polymer, polyvinyl alcohol, polyvinylidene fluoride, etc.

Each of the positive electrode and the negative electrode of the all-solid-state battery according to the present disclosure is not particularly limited, and may be made of a material well-known in the art.

The negative electrode of the all-solid-state battery may include the lithium metal alone or may include a stack in which a negative electrode active material is stacked on a negative electrode current collector. The negative electrode active material may be one selected from the group consisting of lithium metal, lithium alloy, lithium metal composite oxide, lithium-containing titanium composite oxide (LTO), and combinations thereof. The negative electrode active material may include, for example, Li₄Ti₅O₁₂, or LiFe₂O₃.

The positive electrode of the all-solid-state battery according to the present disclosure is not particularly limited, and may be made of a well-known material used in the all-solid-state battery. A positive electrode active material may vary depending on use of the lithium secondary battery, and may include lithium metal oxide such as LiNi_{0.8-x}Co_{0.2}AlₓO₂, LiCoₓMn_{y}O₂, LiNiₓCo_{y}O₂, LiNiₓMn_{y}O₂, LiNiₓCo_{y}Mn_{z}O₂, LiCoO₂, LiNiO₂, LiMnO₂, LiFePO₄, LiCoPO₄, LiMnPO₄ and Li₄Ti₅O₁₂, chalcogenides such as Cu₂Mo₆S₈, FeS, CoS and MiS, or oxides, sulfides, or halides such as TiS₂, ZrS₂, RuO₂, Co₃O₄, Mo₆S₈, or V₂O₅.

The positive electrode may further contain a binder. The binder is not particularly limited. A fluorine-containing binder such as polyvinylidene fluoride (PVDF) or polytetrafluoroethylene (PTFE) may be used as the binder.

A conductive material may be additionally contained in the positive electrode. The conductive material is not particularly limited as long as it may improve the conductivity of the positive electrode. The conductive material may include nickel powder, cobalt oxide, titanium oxide, carbon, and the like. The carbon may include one or more selected from the group consisting of ketjen black, acetylene black, furnace black, graphite, carbon fiber, and fullerene.

A manufacturing scheme of the all-solid-state battery having the above configuration is not particularly limited in the present disclosure. The all-solid-state battery having the above configuration may be manufactured using a known method. For example, the solid electrolyte may be placed between the positive electrode and the negative electrode to form an assembly which in turn is subjected to compression molding to form a cell.

The cell may be installed in a housing and then sealed using heat compression or the like. The housing may include a laminate pack made of aluminum or stainless steel, or a cylindrical or prismatic container made of a metal.

The all-solid-state battery according to the present disclosure is safe and has a high energy density, and thus may be preferably applied as an alternative to renewable energy or as a power source for electric vehicles.

Hereinafter, the present disclosure will be described in more detail with reference to Examples of the present disclosure. Examples are presented for describing the present disclosure. The present disclosure is not limited thereto.

### Present Example 1: Preparing of Gallium and Tellurium-Doped Solid Electrolyte

(a) Li₂O₃, Ga₂O₃, La₂O₃, ZrO₂, and TeO₂ are prepared as lithium precursor, gallium precursor, lanthanum precursor, zirconium precursor, and tellurium precursor, respectively. Then, Li₂O₃, Ga₂O₃, La₂O₃, ZrO₂, and TeO₂ are mixed with each other such that a content of Li₂O₃: a content of Ga₂O₃; a content of La₂O₃; a content of ZrO₂; and a content of TeO₂ is in a range of 1:0.016 to 0.092:1.92 to 1.95:0.846 to 0.803:0.026 to 0.157. The mixture is mixed with isopropyl alcohol solvent to produce a mixed solution. Ball-milling is performed on the mixed solution. Specifically, the ball-milling is performed at 300 to 400 rpm for 1 to 4 hours in a planetary ball-milling scheme using balls having a diameter of 3 to 5 mm.

(b) The ball-milled mixture is calcinated at a temperature of 950° C. for 12 to 24 hours.

(c) Further ball-milling is performed on the calcinated mixture at 300 to 400 rpm for 1 to 4 hours.

(d) Pellets are produced using the mixture subjected to the ball-milling in (c) under a condition of 3 to 5 tons and 30 to 60 s, and is subjected to CIP (Cold Isostatic Pressing), and then is calcinated at each of following conditions: at a temperature of 1000 to 1100° C. for 4 hours, at a temperature of 1050° C. for 8 hours, and at a temperature of 1050° C. for 12 hours.

According to the above preparing method, resulting solid electrolyte Li_{6.75}Ga_{0.25}La₃Zr_{1.75}Te_{0.25}O₁₂ has been prepared.

### Present Example 2: Preparing of Pellet Containing Gallium and Tellurium-Doped Solid Electrolyte

0.5 grams of powders made of the solid electrolyte as prepared according to Present Example 1 is put into a 15 pie size mold and is compressed at 3 tons for 30 s to prepare preliminary pellets, which in turn are subjected to a CIP process (250 MPa, 5 min), such that the preliminary pellets are densified. Thus, final pellets are prepared.

### Comparative Example 1: Preparing of Conventional LLZO Solid Electrolyte

A solid electrolyte is prepared in the same way as that in Present Example 1, except that the gallium precursor and the tellurium precursor are not used compared to Present Example 1.

### Comparative Example 2: Preparing of all-Solid-State Battery Including Conventional LLZO Solid Electrolyte

An all-solid-state battery is manufactured is prepared in the same way as that in Present Example 2, except that the solid electrolyte according to Comparative Example 1 is used instead of the solid electrolyte according to Present Example 1.

### Experimental Example 1: XRD Analysis of Gallium and Tellurium-Doped Solid Electrolyte Based on Calcination Condition

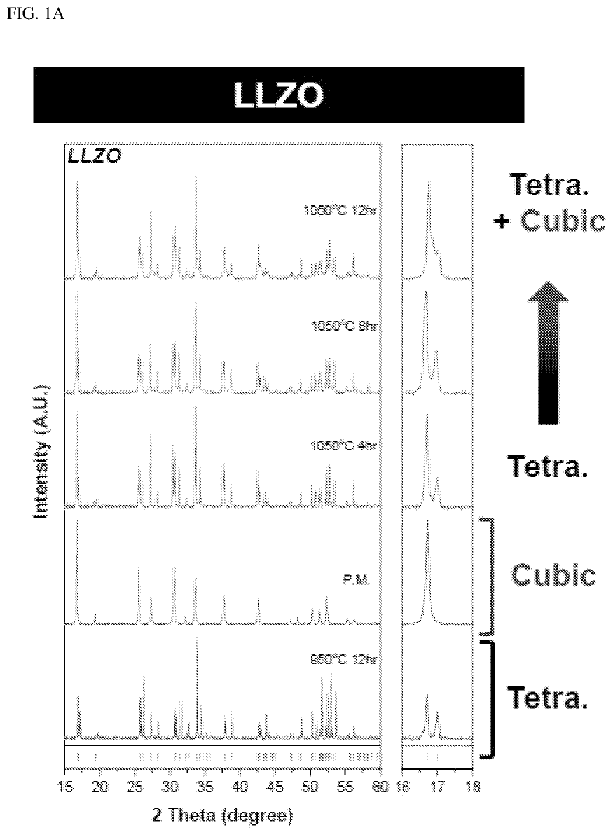

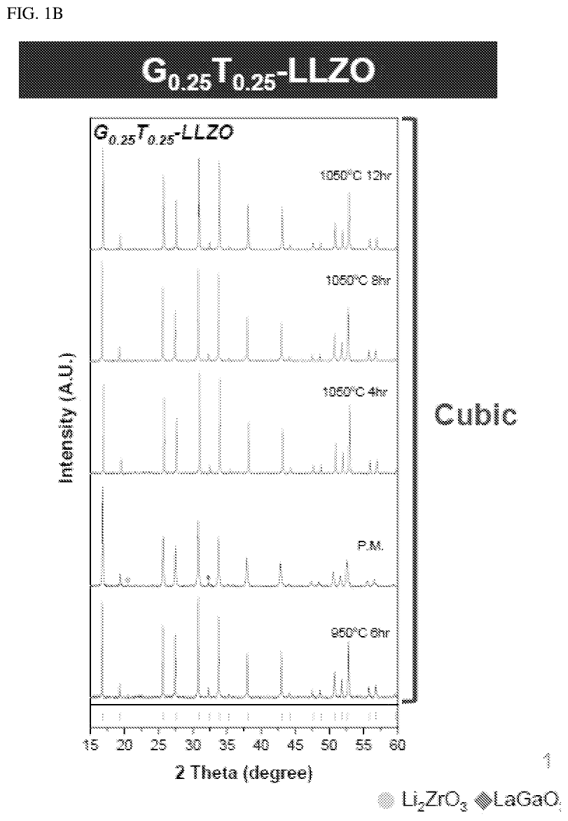

The solid electrolyte is prepared according to each of Present Example 1 and Comparative Example 1, and a result of XRD analysis thereof using a jade analysis method is shown in each of FIG. 1A and FIG. 1B.

Specifically, FIG. 1A is a graph of an XRD analysis result based on a calcination condition of the solid electrolyte as prepared according to Comparative Example 1.

FIG. 1B is a graph of an XRD analysis result based on a calcination condition of the solid electrolyte as prepared according to Present Example 1.

Referring to FIG. 1A, it is identified that the solid electrolyte according to Comparative Example 1 exhibits a tetra phase based on the calcination condition, and as the calcination time increases at a high temperature, a percentage of a cubic phase increases.

However, referring to FIG. 1B, it is identified that the solid electrolyte according to Present Example 1 containing gallium and tellurium at each of certain contents exhibits only the cubic phase regardless of the calcination condition.

### Experimental Example 2: Analysis of Electrical Conductivity of all-Solid-State Battery Including Gallium and Tellurium-Doped Solid Electrolyte

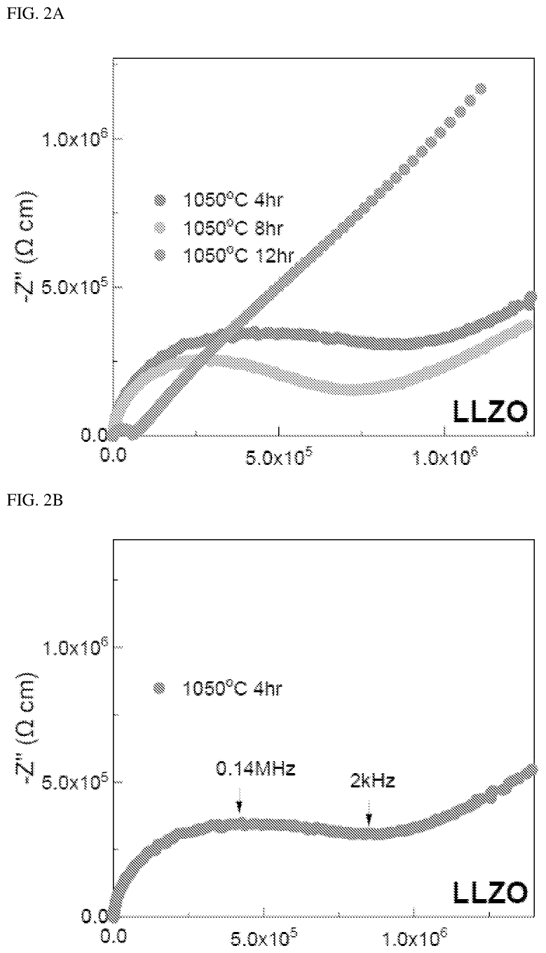

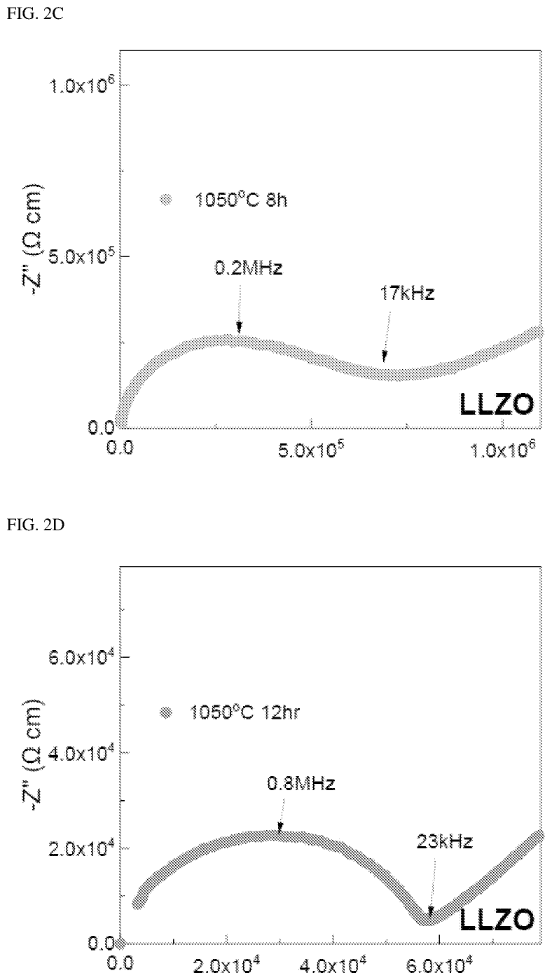

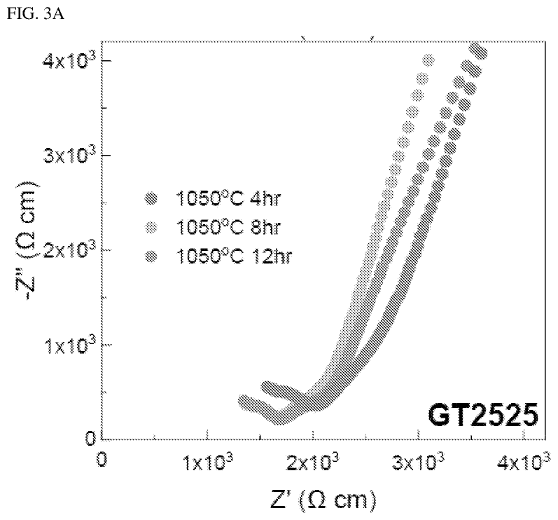

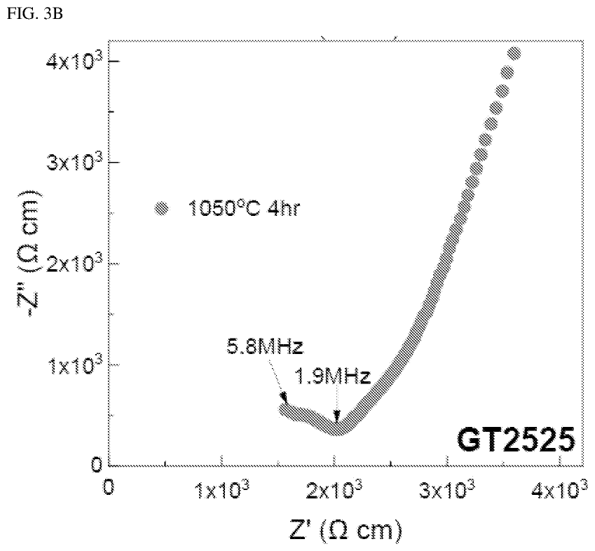

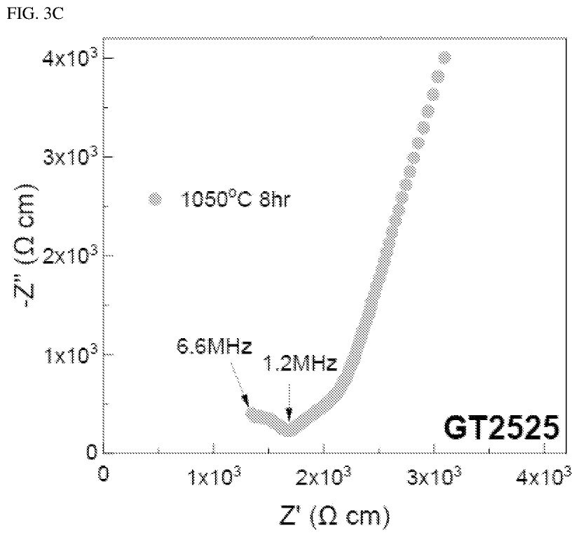

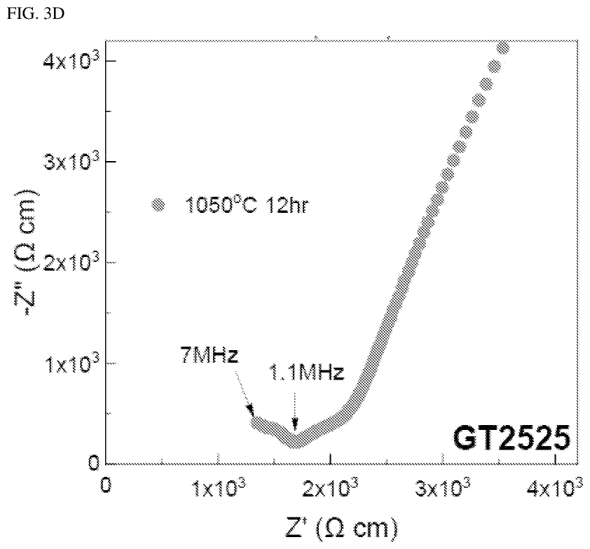

The all-solid-state battery is prepared according to each of Present Example 2 and Comparative Example 2, and the electrical conductivity thereof is analyzed using a 2 probe impedance measurement method, and a result is shown in each of FIG. 2A to FIG. 3D.

Specifically, FIG. 2A is an X-ray diffraction analysis graph based on a calcination condition of solid electrolyte in an all-solid-state battery as prepared according to Comparative Example 2. FIG. 2B is an X-ray diffraction analysis graph of an all-solid-state battery including solid electrolyte calcinated for 4 hours at a temperature of 1050° C. in FIG. 2A. FIG. 2C is an X-ray diffraction analysis graph of an all-solid-state battery including solid electrolyte calcinated for 8 hours at a temperature of 1050° C. in FIG. 2A. FIG. 2D is an X-ray diffraction analysis graph of an all-solid-state battery including solid electrolyte calcinated for 12 hours at a temperature of 1050° C. in FIG. 2A.

FIG. 3A is an X-ray diffraction analysis graph based on a calcination condition of solid electrolyte in an all-solid-state battery as prepared according to Present Example 2. FIG. 3B is an X-ray diffraction analysis graph of an all-solid-state battery including solid electrolyte calcinated for 4 hours at a temperature of 1050° C. in FIG. 3A. FIG. 3C is a graph of X-ray diffraction analysis of an all-solid-state battery including solid electrolyte calcinated for 8 hours at a temperature of 1050° C. in FIG. 3A. FIG. 3D is an X-ray diffraction analysis graph of an all-solid-state battery including solid electrolyte calcinated for 12 hours at a temperature of 1050° C. in FIG. 3A.

Referring to FIG. 2A to FIG. 3D, it may be identified that the electrical conductivity improves as the calcination temperature increases.

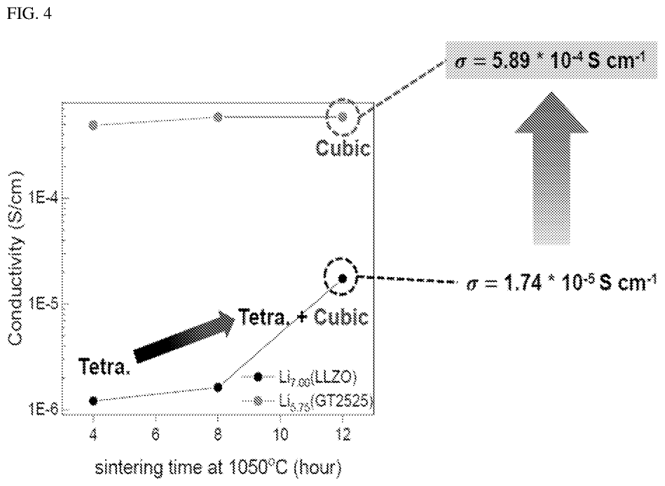

Further, FIG. 4 is a graph showing the electrical conductivity based on a calcination condition of the solid electrolyte in the all-solid-state battery as prepared according to each of Present Example 2 and Comparative Example 2.

Referring to FIG. 4, it may be identified that the electrical conductivity of the all-solid-state battery according to Present Example 2 is higher than that of the all-solid-state battery according to Comparative Example 2 under all calcination conditions.

That is, the solid electrolyte included in the all-solid-state battery as prepared according to Present Example contains the LLZO compound doped with gallium and tellurium in a specific content range and is prepared under a specific calcination condition. Thus, the solid electrolyte exhibits a stable cubic phase in all calcination conditions. Thus, the electrical conductivity of the all-solid-state battery including the same is high.

Although the present disclosure has been described with reference to preferred embodiments of the present disclosure, it will be understood that those skilled in the art may modify and change the present disclosure variously without departing from the spirit and scope of the present disclosure as described in the Claims below.

What is claimed is:

1. Solid electrolyte containing a lithium lanthanum zirconium oxide-based compound doped with gallium (Ga) and tellurium (Te), wherein the lithium lanthanum zirconium oxide-based compound doped with gallium (Ga) and tellurium (Te) is represented by a following Chemical Formula 1:
Liₐ₋ₓGaₓLa_{b}Zr_{c-y}Te_{y}O₁₂
(5≤a≤9,0<x≤4,2≤b≤4,1≤c≤3,0<y<1). [Chemical Formula 1]

2. The solid electrolyte of claim 1, wherein the lithium lanthanum zirconium oxide-based compound doped with gallium (Ga) and tellurium (Te) is represented by a following Chemical Formula 2:
Li₇₋ₓGaₓLa₃Zr_{2-y}Te_{y}O₁₂
(0<x≤3,0<y<1) [Chemical Formula 2]

3. The solid electrolyte of claim 1, wherein the lithium lanthanum zirconium oxide-based compound doped with gallium (Ga) and tellurium (Te) has a garnet cubic phase.

4. The solid electrolyte of claim 1, further containing γ-Al₂O₃.

5. A method for preparing the solid electrolyte of claim 1, the method comprising:
(a) mixing a lithium precursor, a gallium precursor, a lanthanum precursor, a zirconium precursor, and a tellurium precursor with each other to prepare a mixture, and ball-milling the mixture; and
(b) calcinating the ball-milled mixture.

6. The method of claim 5, wherein the ball-milling includes planetary ball-milling.

7. The method of claim 5, wherein (a) further includes mixing the mixture with a solvent before the ball-milling.

8. The method of claim 5, wherein the ball-milling is performed at 300 to 700 rpm.

9. The method of claim 5, wherein the lithium precursor, the gallium precursor, the lanthanum precursor, the zirconium precursor, and the tellurium precursor are Li₂O₃, Ga₂O₃, La₂O₃, ZrO₂, and TeO₂, respectively.

10. The method of claim 5, further comprising: (c) ball-milling the calcinated mixture after (b).

11. The method of claim 10, further comprising adding 7-Al₂O₃ to the calcinated mixture before (c).

12. The method of claim 10, wherein the ball-milling in (c) includes planetary ball-milling.

13. An all-solid-state battery comprising:
a positive electrode;
a negative electrode; and
solid electrolyte interposed between the positive electrode and the negative electrode, wherein the solid electrolyte includes the solid electrolyte of claim 1.
